(19) United States
(12) Patent Application Publication
(10) Pub. No.: US 2025/0179871 A1
(43) Pub. Date: Jun. 5, 2025

(54) BURGLAR TRAPPING SYSTEM

(71) Applicants: Athimoolam Sreenivasa Sundar, Tirunelveli (IN); Priya Stanley, Coimbatore (IN)

(72) Inventor: Athimoolam Sreenivasa Sundar, Tirunelveli (IN)

(21) Appl. No.: 19/043,965

(22) Filed: Feb. 3, 2025

(30) Foreign Application Priority Data
Aug. 2, 2024 (IN) 202441058541

(51) Int. Cl. E06B 9/06; A01M 23/20; E05F 15/668

(52) U.S. Cl. CPC E06B 9/0661; E05F 15/668; E06B 9/0623; A01M 23/20; E05Y 2400/44; E05Y 2900/144

(57) ABSTRACT

A burglar trapping system includes a grill assembly having a collapsible grill door adapted to be operated in a collapsed condition and an expanded condition and a motor adapted to operate the collapsible grill door. A sensing module is configured to detect a pressure applied on an object and a communication unit is configured to receive the detected pressure from the plurality of sensors and/or a triggering input from a remote electronic device and generate an input based on one of the detected pressure and the triggering input. A control unit in communication with the communication unit is configured to receive the input from the communication unit and operate the motor to move the collapsible grill door in the expanded condition.

### FIELD OF THE INVENTION

The present disclosure generally relates to security systems, and more particularly, the present disclosure relates to a system for trapping unauthorised intruder within a space.

### BACKGROUND

High risk financial and security areas such as safety lockers, vaults, and Automated Teller Machines (ATMs) have become an integral part of banking infrastructure. These areas provide convenient access to cash, safe deposit of valuables in addition to other banking services to millions of users globally. However, the security of the said financial instruments has become a paramount concern as instances of theft and tampering continue to rise. Traditional security systems predominantly rely on Closed-Circuit Television (CCTV) surveillance, which records any criminal activity within a space or a cabin. However, this method proves inadequate as it merely captures the event without preventing the crime. The criminals often have ample time to escape before law enforcement can intervene, rendering the surveillance footage useful only for post-incident investigation. Additionally, CCTV systems can be easily bypassed by cutting power supplies or covering the camera lenses.

Additionally, the cabins are often equipped with alarm systems that trigger upon detecting forced entry or tampering. While alarms can alert nearby personnel or authorities, their effectiveness heavily depends on the response time, which is not always immediate. Moreover, the alarms do not physically prevent the criminal from continuing their actions or escaping the scene. Thus, the reliance on alarms alone does not provide a robust deterrent against thefts.

Another prevalent security measure is the use of physical guards. Although having a security guard on site can deter criminal activities, the approach is not foolproof. Guards can be overpowered, incapacitated, or even bypassed if criminals choose to strike during unguarded hours. The presence of human guards also adds to the operational costs and may not be feasible for all cabin locations, especially in remote or less populated areas.

Therefore, in view of the above, it is desirable to provide a system that overcomes one or more problems associated with the existing art.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment, a burglar trapping system is provided. The system includes a grill assembly mounted on at least one entrance of a space accommodating an object. The grill assembly further includes a collapsible grill door adapted to be operated in a collapsed condition and an expanded condition. The collapsible grill door conceals the at least one entrance of the space in the expanded condition. The collapsible grill door includes a motor adapted to operate the collapsible grill door between the collapsed condition and the expanded condition. A sensing module is provided with a plurality of sensors located at a plurality of predetermined positions on the object and configured to detect a pressure applied on the object. A communication unit is communicatively coupled to the sensing module and configured to receive at least one of the detected pressure from the plurality of sensors and a triggering input from a remote electronic device indicative of an instruction to operate the grill assembly in the expanded condition. Further, the communication unit is configured to generate an input based on one of the detected pressure and the triggering input. The input is indicative of a security breach in the object. Furthermore, a control unit in communication with the communication unit is provided. The control unit is configured to receive the input from the communication unit and operate the motor to move the collapsible grill door in the expanded condition.

In another embodiment, a grill assembly is provided. The drill assembly includes a collapsible grill door having a top portion and a bottom portion distal to the top portion. A bracket adapted to support a bottom portion of the collapsible grill door in the collapsed condition. A frame adapted to movably coupled to the bracket and adapted to support the top portion of the collapsible grill door. Further, the frame includes a pair of first structural members disposed vertically opposite to each other. The bracket is movably coupled to the pair of first structural members. A pair of second structural members is disposed horizontally opposite to each other. The one of the pair of second structural members is adapted to support a motor and the top portion of the collapsible grill door. The pair of first structural members and the pair of second structural members are attached to each other to form the frame. A gear assembly is coupled to the motor and adapted to convert a rotary movement into a linear movement.

Further, a pair of latch mechanisms is provided in the grill assembly. The each latch mechanism disposed on an outer periphery of the respective first structural member. The each latch mechanism is adapted to be engaged with the gear assembly and the bracket to release the collapsible grill door from the collapsed condition to the expanded condition. Furthermore, a plurality of slide locks is disposed along bottom edges of the pair of second structural members. The plurality of slide locks is adapted to be engaged with the collapsible grill door in the expanded condition such that the movement of the collapsible grill door is restricted.

To further clarify the advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a block diagram of a burglar trapping system, in accordance with an embodiment of the present invention;

FIG. 2 illustrates a front view of the grill assembly in a collapsed condition, in accordance with an embodiment of the present invention;

FIG. 3A illustrates a front view of the grill assembly in the expanded condition, in accordance with an embodiment of the present invention;

FIG. 3B illustrates an isometric view of the grill assembly in the expanded condition, in accordance with an embodiment of the present invention;

FIG. 4 illustrates a schematic view of a mechanism for releasing a collapsible grill door, in accordance with an embodiment of the present invention; and

FIG. 5 illustrates an engaging portion of a bracket in the grill assembly, in accordance with an embodiment of the present invention.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system 100, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system 100, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described tin connection with one or more embodiments may be found in one embodiment, or may be found in more than one embodiment, or may be found in all embodiments, or may be found in no embodiments. Although one or more features and/or elements may be described in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the present disclosure will be described below in detail with reference to the accompanying drawings.

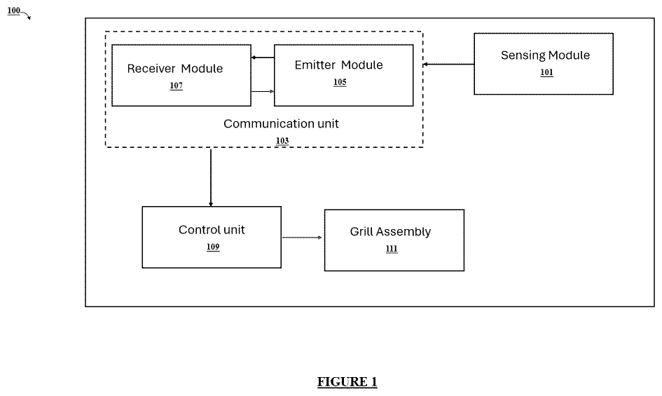

FIG. 1 illustrates a block diagram of a burglar trapping system 100, in accordance with an embodiment of the present invention. The present disclosure relates to a burglar trapping system 100 designed to enhance security of a space. In an embodiment, the space may include but not limited to an area accommodating an object such as an Automated Teller Machine (ATM), safety vault, locker etc. Hereinafter, the burglar trapping system 100 may alternatively be referred to as a system 100 hereinafter. The system 100 may employ a combination of mechanical and electronic components to detect and respond to any unauthorized attempt to access the space. The system 100 may include but not limited to a grill assembly 200, a sensing module 101, a communication unit 203, a control unit 109 and a notification mechanism to swiftly trap an intruder within the space and sent an alert notification. The system 100 as disclosed in the present disclosure may deter potential burglars and aid in their immediate apprehension, significantly reducing the risk of theft and ensuring safety of the objects placed inside the space. The working mechanism of the system 100 in detecting an intrusion is described in detail in subsequent paragraphs.

Referring to FIG. 1, the sensing module 101 may include a plurality of sensors configured to detect a pressure applied on the object. In an embodiment, the plurality of sensors may be located at predetermined locations on the object. The plurality of sensors may be configured to detect a pressure applied at the predetermined locations on the object. In a non-limiting embodiment, the plurality of sensors may be one of a pressure sensor or a touch sensor. In one embodiment, when the object is embodied as the ATM, the plurality of sensors may be positioned inside a body of the ATM at the predetermined locations. In another embodiment, when the object is embodied as the safety locker or the safety vault, the plurality of sensors may be positioned around a keyhole of the safety locker. Further, the sensing module 101 may be communicatively coupled with the communication unit 203. The communication unit 203 may be provided with a receiver module 107 and an emitter module 105.

In an embodiment, the emitter module 105 may be provided in the object and communicatively coupled with the plurality of sensors. In an embodiment, the receiver module 107 may be positioned proximal to the grill assembly 200. The receiver module 107 may be communicatively coupled with the emitter module 105 and the control unit 109. The plurality of sensors in the sensing module 101 may be configured to detect the pressure applied on the object and send the detected pressure to the emitter module 105. The emitter module 105 may be configured to receive the detected pressure from the plurality of sensors and transmit the detected pressure to the receiver module 107. In one embodiment, the emitter module 105 may be physically connected to the receiver module 107 through electrical wires. In another embodiment, the emitter module 105 may wirelessly transmit the detected pressures to the receiver module 107. The emitter module 105 may incorporates various transistors and operational amplifiers to amplify a signal indicative of the detected pressure from the sensing module 101 thereby maintaining signal integrity.

Further, the receiver module 107 may be configured to receive at least one of the detected pressure from the emitter module 105 and a triggering input from a remote electronic device. The triggering input may be indicative of an instruction to operate the grill assembly 200 in an expanded condition. In a non-limiting embodiment, the remote electronic device may be a mobile phone or a remote controller device. In an example, the triggering input may be provided by an operator sensing an intrusion into the space. Further, the communication unit 203 may be configured to generate an input based on one of the detected pressure and the triggering input. The communication unit 203 may be configured generate the input, if the detect pressure by the plurality of sensors is more than a threshold limit. In an embodiment, the threshold limit of pressure for generating the input may be in a range from 100 Newtons to 500 N. The input may be indicative of a security breach in the space.

Further, the communication unit 203 may be communicatively coupled with the control unit 109. The control unit 109 may include a plurality of transistors, a plurality of resistors embedded on a Printed Circuit Board (PCB). The control unit 109 may be adapted to receive the input from the communication unit 203. The control unit 109 is configured to receive the input from the communication unit 203 and operate the motor 204 to move the collapsible grill door 202 from a collapsed condition to the expanded condition. Upon receiving the input from the communication unit 203, the control unit 109 processes the information and activates the motor 204 which in turn engages a plurality of mechanical components of the grill assembly 200. The actuation of the motor 204 may deploy a collapsible grill door 202 in the grill assembly 200 trapping unauthorized intruder. In addition to the deployment of the collapsible grill door 202, the system 100 may trigger a loud siren and initiate an SOS message to predesignated authorities. The structural and constructional aspects of the grill assembly 200 are described in subsequent paragraphs.

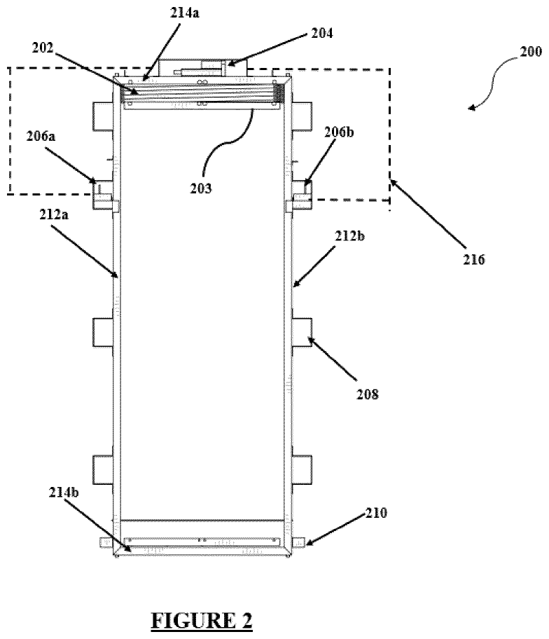

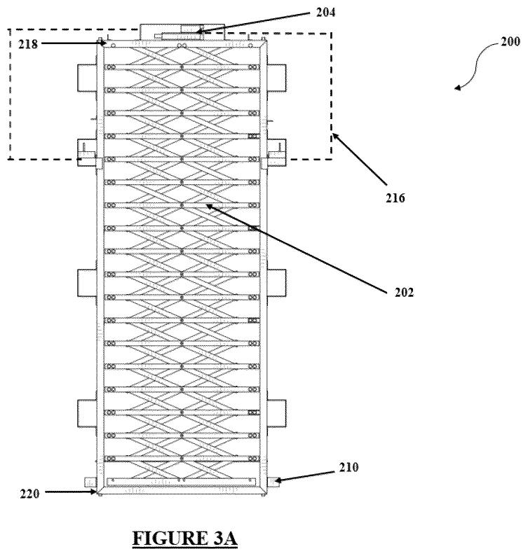

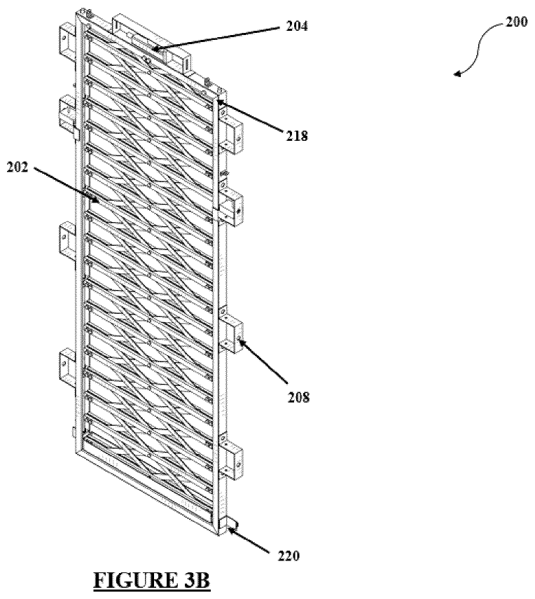

FIG. 2 illustrates a front view of the grill assembly 200 in a collapsed condition, in accordance with an embodiment of the present invention. FIG. 3A illustrates a front view of the grill assembly 200 in the expanded condition, in accordance with an embodiment of the present invention. FIG. 3B illustrates an isometric view of the grill assembly in the expanded condition, in accordance with an embodiment of the present invention. Though a plurality of wires 216 are not illustrated in FIG. 3B, it should not be construed as limiting and there may be other embodiment of the present disclosure.

Referring to FIGS. 2 to 3B, the grill assembly 200 may include the collapsible grill door 202 adapted to be operated between the collapsed condition and the expanded condition. In an embodiment, the grill assembly 200 may be mounted on at least one entrance of the space. The collapsible grill door 202 may be adapted to conceal the at least one entrance of the space in the expanded condition. The collapsible grill door 202 is provided with a top portion 218 and a bottom portion 220 distal to the top portion 218. Further, a bracket 203 may be adapted to support the bottom portion 220 of the collapsible grill door 202 in the collapsed condition. The collapsible grill door 202 may be provided with a series of interlocking metal slats adapted to collapse and expand in the collapsed condition and the expanded condition respectively.

Further, the grill assembly 200 may include a frame adapted to movably coupled to the bracket 203. The frame may be adapted to support the movement of the collapsible grill door 202 between the collapsed condition and the expanded condition. The frame may further provide structural stability and maintain alignment of the collapsible grill door 202 during its deployment. Furthermore, the frame may be adapted to support the top portion 218 of the collapsible grill door 202. The frame may include a pair of first structural members 212a, 212b disposed vertically opposite to each other and a pair of second structural members 214a, 214b disposed horizontally opposite to each other. The bracket 203 may be movably coupled to the pair of first structural members 212a, 212b. Moreover, one of the pair of second structural members 214a, 214b may be adapted to support the motor 204 and the top portion 218 of the collapsible grill door 202. The pair of first structural members 212a, 212b and the pair of second structural members 214a, 214b may be attached to each other to form the frame.

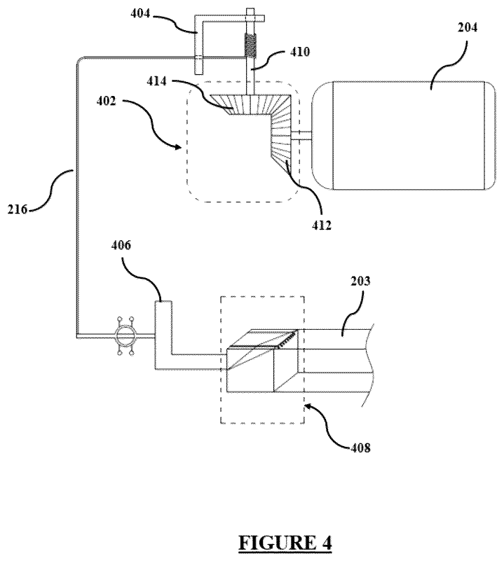

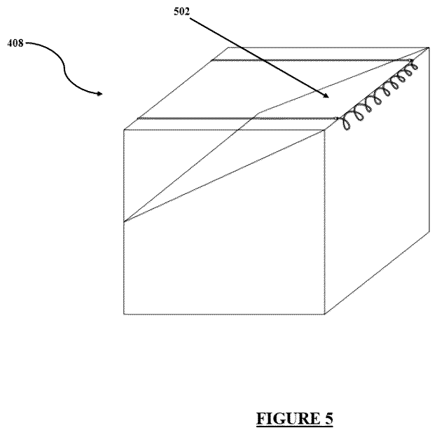

FIG. 4 illustrates a schematic view of a mechanism for releasing the collapsible grill door 202, in accordance with an embodiment of the present invention and FIG. 5 illustrates an engaging portion 408 of a bracket 203 in the grill assembly 200, in accordance with an embodiment of the present invention.

Further, the grill assembly 200 may include a gear assembly 402 coupled to the motor 204 and adapted to convert a rotary movement into a linear movement. In an embodiment, the gear assembly 402 may be mounted on one of the pair of second structural members 214a, 214b. The gear assembly 402 may include a bevel gear 412 in contact with an axial gear 414. The bevel gear 412 may be coupled with the motor 204 and adapted to transfer a torsional momentum from the motor 204 to the axial gear 414. The axial gear 414 in the gear assembly 402 may be adapted to transfer the rotational movement of the motor 204 to a linear movement. An axial pole 410 may be coupled with the axial gear 414 and rotate along with the axial gear 414. A fixed clamp 404 may be positioned above the gear assembly and the axial pole 410 may pass through the fixed clamp 404 via a hole. The fixed clamp 404 may be adapted to provide stability to the axial pole 410.

The grill assembly 200 may include a pair of latch mechanisms 206a, 206b disposed on an outer periphery of the pair of first structural members 212a, 212b. Each latch mechanism 206a, 206b may be adapted to be engaged with the gear assembly 402 and the bracket 203 to release the collapsible grill door 202 from the collapsed condition to the expanded condition. Furthermore, the grill assembly 200 may include a plurality of slide locks 210 disposed along bottom edges of the pair of second structural members 214a, 214b. The plurality of slide locks 210 may be adapted to be engaged with the collapsible grill door 202 in the expanded condition such that the movement of the collapsible grill door 202 is restricted.

Further, each latch mechanism 206a, 206b may include a housing 402, and a locking member 406 disposed within the housing 402. The plurality of steel wires 216 may connect the locking member 406 with the axial pole 410 extending from the gear assembly 402 via the fixed clamp 404. The locking member 406 may be adapted to be engaged with an engaging portion 408 of the bracket 203. The engaging portion 408 may be provided on either ends of the bracket 203 interacting with the pair of first structural members 212a, 212b of the frame. The engaging portion 408 may be disposed with an oblique wall 502 slanting against the locking member 406 such that an upward movement of the collapsible grill door 202 engages the locking member 406 in a snap lock arrangement. In the collapsed condition, the locking member 406 may be adapted to be engaged with the engaging portion 408 of the bracket 203. Similarly, in the expanded condition, the locking member 406 may be adapted to be disengaged with the engaging portion 408 of the bracket 203.

Further, a linear bearing may be disposed in the pair of first structural members 212a, 212b to enable free movement of the collapsible grill door 202 along the pair of first structural members 212a, 212b. The pair of first structural members 212a, 212b in the frame may be provided with a plurality of clamp 208 fixtures in an outer periphery to attach the grill assembly 200 in the at least one entrance of the space. The plurality of clamp 208 fixtures may securely attach the grill assembly 200 to the at least one entrance of the space.

Further, the grill assembly 200 may include the motor 204 configured to operate the collapsible grill door 202 between the collapsed condition and the expanded condition. In an embodiment, the motor 204 may be operated by the control unit 109 upon receiving the input from the communication unit 203. When the input is received by the control unit 109, the motor 204 may be operated by the control unit 109 to release and deploy the collapsable grill door from the collapsed condition to the expanded condition. The motor 204 may be adapted to be operated by the control unit 109 to pull the locking member 406 in the pair of latch mechanisms 206a, 206b via the plurality of steel wires 216. One end of the steel wire 216 may be wound in the axial pole 410 and the other end may be connected to the locking member 406. The gear assembly 402 may be adapted to convert the rotary movement of the motor 204 into the linear movement. When the motor 204 is operated, the rotary movement is transferred to the axial gear 414 and the axial pole 410 is rotated by the axial gear 414. The rotation of the axial pole 410 may wound the steel wire 216 and may pull the locking member 406. The locking member 406 may be adapted to be pulled vertically in an upward direction by the plurality of steel wires 216 detaching the bracket 203 from the pair of latch mechanisms 206a, 206b. The detachment of the locking member 406 from the bracket 203 releases the collapsible grill door 202 from the locking member 406.

Upon detaching the locking member 406 from the bracket 203, the bracket 203 may be adapted to be moved vertically in a downward direction along the pair of first structural members 212a, 212b of the frame. When the bracket 203 is detached from the locking member 406, the collapsible grill door 202 is moved from the collapsed condition to the expanded condition. In the expanded condition, the plurality of slide locks 210 may be adapted to be engaged with the collapsible grill door 202 such that the movement of the collapsible grill door 202 is restricted. In an embodiment, the collapsible grill door 202 may be disengaged from the plurality of slide locks 210 by opening through a dedicated key. After disengagement of the collapsible grill door 202, the collapsible grill door 202 may be lifted manually to the collapsed condition. In the collapsed condition, the locking member 406 engages with the engaging portion 408 of the bracket 203 in the snap lock arrangement and hold the collapsible grill door 202 in the collapsed condition. Further, the frame may be provided with a plurality of springs positioned at the bottom portion 220. The plurality of springs may be adapted to dissipate kinetic energy released when the collapsible grill door 202 is operated to the expanded condition.

The advantages of the burglar trapping system 100 are described now. The system 100 disclosed in the present disclosure provides for an effective way for protecting high risk security areas. The system 100 provides a robust, reliable, and technologically advanced solution that addresses current security challenges the secured spaces such as ATM kiosk, safety vaults, and lockers. The system 100 provides for improved detection speed, response time, and system 100 resilience enhancing security and improved operational efficiency. The system 100 provides for both automated and manual trapping mechanisms. The automatic triggering mechanism deploys the collapsible grill door 202 trapping the intruder based on sensing pressure on the object. The collapsible grill door 202 may also be deployed manually by the triggering input, if a suspicious activity is noticed. This provides in flexibility in the operation of the system 100 not entirely relying upon the automation.

Additionally, the plurality of slide locks 210 engages securely with the collapsible grill door 202 restricting breakage or accessibility. The collapsible grill door 202 may only be lifted upon disengaging the plurality of slide locks 210 using a designated master key. This feature of engaging the collapsible grill door 202 with the plurality of slide locks 210 ensures the intruder is trapped inside the space until arrival of the notified authorities.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A burglar trapping system comprising:
a grill assembly mounted on at least one entrance of a space accommodating an object, the grill assembly comprising:
a collapsible grill door adapted to be operated in a collapsed condition and an expanded condition, wherein the collapsible grill door conceals the at least one entrance of the space in the expanded condition;
a motor adapted to operate the collapsible grill door between the collapsed condition and the expanded condition;
a sensing module having a plurality of sensors located at a plurality of predetermined positions on the object and configured to detect a pressure applied on the object;
a communication unit communicatively coupled to the sensing module, the communication unit configured to:
receive at least one of:
the detected pressure from the plurality of sensors; and
a triggering input, from a remote electronic device, indicative of an instruction to operate the grill assembly in the expanded condition;
generate an input based on one of the detected pressure and the triggering input, wherein the input is indicative of a security breach in the object; and
a control unit in communication with the communication unit and configured to:
receive the input from the communication unit; and
operate the motor to move the collapsible grill door in the expanded condition.

2. The system as claimed in claim 1, wherein the communication unit comprises:
an emitter module provided in the object and communicatively coupled with the plurality of sensors, wherein the emitter module is configured to receive the detected pressure from the plurality of sensors and transmit the detected pressure; and
a receiver module provided in proximity to the grill assembly and communicatively coupled with the emitter module and the control unit, wherein the receiver module is configured to receive at least one of the detected pressure from the emitter module and the triggering input from the remote electronic device, generate the input and transmit the input to the control unit.

3. The system as claimed in claim 1, wherein the grill assembly comprises:
the collapsible grill door having a top portion and a bottom portion distal to the top portion;
a bracket adapted to support the bottom portion of the collapsible grill door in the collapsed condition;
a frame adapted to movably coupled to the bracket and adapted to support the top portion of the collapsible grill door, wherein the frame comprises:
a pair of first structural members disposed vertically opposite to each other, wherein the bracket is movably coupled to the pair of first structural members; and
a pair of second structural members disposed horizontally opposite to each other, wherein one of the pair of second structural members is adapted to support the motor and the top portion of the collapsible grill door,
wherein the pair of first structural members and the pair of second structural members are attached to each other to form the frame,
a gear assembly coupled to the motor and adapted to convert a rotary movement into a linear movement;
a pair of latch mechanisms, each latch mechanism disposed on an outer periphery of the respective first structural member, wherein each latch mechanism is adapted to be engaged with the gear assembly and the bracket to release the collapsible grill door from the collapsed condition to the expanded condition;
a plurality of slide locks disposed along bottom edges of the pair of second structural members, wherein the plurality of slide locks is adapted to be engaged with the collapsible grill door in the expanded condition such that the movement of the collapsible grill door is restricted.

4. The system as claimed in claim 2, wherein each latch mechanism comprises:
a housing; and
a locking member disposed within the housing and adapted to engage with an engaging portion of the bracket.

5. The system as claimed in claim 3, wherein a plurality of steel wires connects the locking member with the gear assembly via a fixed clamp.

6. The system as claimed in claim 2, wherein a linear bearing is disposed in the pair of first structural members to enable free movement of the collapsible grill door along the pair of first structural members.

7. The system as claimed in claim 2, wherein the pair of first structural members in the frame is provided with a plurality of clamp fixtures in an outer periphery to attach the grill assembly in the at least one entrance of the space.

8. The system as claimed in claim 4, wherein in the collapsed condition, the locking member is adapted to be engaged with the engaging portion of the bracket, and in the expanded condition, the locking member is adapted to be disengaged with the engaging portion of the bracket.

9. The system as claimed in claim 4, wherein the engaging portion is provided on either ends of the bracket interacting with the pair of first structural members of the frame and disposed with an oblique wall that slants against the locking member such that an upward movement of the collapsible grill door engages the locking member in a snap lock arrangement.

10. The system as claimed in claim 9, wherein the motor is adapted to be operated by the control unit to pull the locking member in the pair of latch mechanisms via the steel wire to release the collapsible grill door from the snap lock arrangement with the locking member.

11. The system as claimed in claim 10, wherein the gear assembly is adapted to convert the rotary movement of the motor into the linear movement, and the locking member is adapted to be pulled vertically in an upward direction by the plurality of steel wire detaching the bracket from the latch mechanism.

12. The system as claimed in claim 10, wherein the bracket is adapted to be moved vertically in a downward direction along the pair of first structural members of the frame to operate the collapsible grill door in the expanded condition when the bracket is detached from the latch mechanism.

13. The system as claimed in claim 3, wherein the frame includes a plurality of springs positioned at the bottom portion and dissipate kinetic energy released when the collapsible grill door is operated to the expanded condition.

14. The system as claimed in claim 1, wherein the plurality of sensors is embodied as one of a pressure sensor or a touch sensor.

15. A grill assembly, comprising:
a collapsible grill door having a top portion and a bottom portion distal to the top portion;
a bracket adapted to support a bottom portion of the collapsible grill door in the collapsed condition;
a frame adapted to movably coupled to the bracket and adapted to support the top portion of the collapsible grill door , wherein the frame comprises:
a pair of first structural members disposed vertically opposite to each other, wherein the bracket is movably coupled to the pair of first structural members; and
a pair of second structural members disposed horizontally opposite to each other, wherein one of the pair of second structural members is adapted to support a motor and the top portion of the collapsible grill door,
wherein the pair of first structural members and the pair of second structural members are attached to each other to form the frame,
a gear assembly coupled to the motor and adapted to convert a rotary movement into a linear movement;
a pair of latch mechanisms , each latch mechanism disposed on an outer periphery of the respective first structural member, wherein each latch mechanism is adapted to be engaged with the gear assembly and the bracket to release the collapsible grill door from the collapsed condition to the expanded condition;
a plurality of slide locks disposed along bottom edges of the pair of second structural members, wherein the plurality of slide locks is adapted to be engaged with the collapsible grill door in the expanded condition such that the movement of the collapsible grill door is restricted.

16. The grill assembly as claimed in claim 15, wherein each latch mechanism comprises:
a housing; and
a locking member disposed within the housing and adapted to couple to an engaging portion of the bracket.

17. The grill assembly as claimed in claims 16, wherein a plurality of steel wires connect the locking member with the gear assembly via a fixed clamp and a linear bearing is disposed in the pair of first structural members to enable a free movement of the collapsible grill door along the pair of first structural members, further wherein the pair of first structural members in the frame is provided with a plurality of clamp fixtures in an outer periphery to attach the grill assembly in the entrance of the space.

18. The grill assembly as claimed in claim 17, wherein:
in the collapsed condition, the locking member is adapted to be engaged with the engaging portion of the bracket and in the expanded condition, the locking member is adapted to be disengaged with the engaging portion of the bracket;
the engaging portion is provided on either ends of the bracket interacting with the pair of first structural members of the frame and disposed with an oblique wall that slants against the locking member such that an upward movement of the collapsible grill door engages the locking member in a snap lock arrangement.

19. The grill assembly as claimed in claims 18, wherein the motor is configured to be actuated to pull the locking member in the pair of latch mechanisms via the steel wire to release the collapsible grill door from the snap lock arrangement, further wherein the rotary movement of the motor is converted into the linear movement by the gear assembly and the locking member is adapted to be pulled vertically in an upward direction by the plurality of steel wire detaching the bracket from the latch mechanism.

20. The grill assembly as claimed in claim 19, wherein the bracket is adapted to be moved vertically in a downward direction along the pair of first structural members of the frame to operate the collapsible grill door in the expanded condition when the bracket is detached from the latch mechanism, further wherein the frame includes a plurality of springs positioned at a bottom portion of the frame to absorb and dissipate kinetic energy released when the collapsible grill door is operated to the expanded condition.
